(19) United States
(12) Patent Application Publication
(10) Pub. No.: US 2024/0425725 A1
(43) Pub. Date: Dec. 26, 2024

(54) COATING MATERIAL

(71) Applicant: Nippon Telegraph and Telephone Corporation, Tokyo (JP)

(72) Inventors: Azusa Ishii, Tokyo (JP); Shingo Mineta, Tokyo (JP); Masayuki Tsuda, Tokyo (JP)

(21) Appl. No.: 18/699,228

(22) PCT Filed: Nov. 11, 2021
(86) PCT No.: PCT/JP2021/041539

§ 371 Date: Apr. 5, 2024

(51) Int. Cl. C09J 7/30; C09J 201/00; G01N 17/00

(52) U.S. Cl. CPC C09J 7/30; C09J 201/00; G01N 17/00

(57) ABSTRACT

A coating material includes a base material having a sheet-like or plate-like shape, and a non-adhesive layer and an adhesive layer formed on one surface of the base material. The base material is formed with a material that prevents intrusion of an ultraviolet ray. The non-adhesive layer is formed with a material that does not have adhesiveness to a polymer material, and is formed in a first region of one surface of the base material. The adhesive layer includes a material having adhesiveness to a polymer material, and is formed in a second region in which the first region of the one surface of the base material is interposed.

### CROSS-REFERENCE TO RELATED APPLICATIONS

This application is a national phase entry of PCT Application No. PCT/JP2021/041539, filed on Nov. 11, 2021, which application is hereby incorporated herein by reference.

### TECHNICAL FIELD

The present invention relates to a coating material used in a test for deterioration evaluation.

### BACKGROUND

Evaluation of a state of deterioration of a polymer material, such as a paint and a plastic material, due to ultraviolet rays is performed as follows. First, an accelerated light resistance test, an accelerated weather resistance test, an outdoor exposure test, and the like are performed in a state where a part of a surface of a sample is masked. As a result, both a deteriorated part and an undeteriorated part that is masked are formed on the surface of the sample. Thereafter, comparative analysis between the undeteriorated part and the deteriorated part formed as an index is performed. For example, it is considered that measuring a level difference between the undeteriorated part and the deteriorated part enables evaluation of deterioration such as a wear amount of a material constituting a sample.

### SUMMARY

### Technical Problem

When masking is performed using a general masking tape, an adhesive remains on the surface of the sample when the masking tape is peeled off after execution of a test for deterioration evaluation such as an accelerated light resistance test, an accelerated weather resistance test, and an outdoor exposure test. For this reason, there is the problem that using a tape makes it difficult to obtain an undeteriorated part in a state where there is no attached substance such as an adhesive. For example, there is the problem that measuring the level difference between the undeteriorated part and the deteriorated part for the purpose of evaluating the wear amount leads to an increase in height of the undeteriorated part due to the remained adhesive, and makes it impossible to accurately perform the level difference evaluation. As described above, the conventional technology has the problem that a test for accurate deterioration evaluation cannot be performed.

Embodiments of the present invention have been made to solve the above problems, and an object of embodiments of the present invention is to perform a test for accurate deterioration evaluation.

### Solution to Problem

A coating material according to embodiments of the present invention includes: a base material having a sheet-like or plate-like shape formed with a material that prevents intrusion of an ultraviolet ray; a non-adhesive layer formed with a material that does not have adhesiveness to a polymer material and formed in a first region of one surface of the base material; and an adhesive layer formed with a material that has adhesiveness to the polymer material and formed in a second region in which the first region of the one surface of the base material is interposed, in which the non-adhesive layer is formed with a polymer that does not contain any one of a hydroxyl group, an amino group, a carboxyl group, a carbonyl group, an ester bond, a urethane bond, a urea bond, an imide bond, an imino group, an aldehyde group, a vinyl group, a phenyl group, a nitro group, or a sulfonyl group, and a surface of the non-adhesive layer with a surface of the adhesive layer is capable of contacting a surface of a material to be tested.

### Advantageous Effects

As described above, according to embodiments of the present invention, since the non-adhesive layer and the adhesive layer are provided on one surface of the base material to form a coating material, a test for accurate deterioration evaluation can be performed.

### DESCRIPTION OF THE DRAWINGS

FIG. 1A is a sectional view illustrating a configuration of a coating material according to an embodiment of the present invention.

FIG. 1B is a cross-sectional view illustrating a configuration of another coating material according to the embodiment of the present invention.

FIG. 1C is a cross-sectional view illustrating a partial configuration of another coating material according to the embodiment of the present invention.

FIG. 2A is a plan view illustrating a configuration of a coating material according to the embodiment of the present invention.

FIG. 2B is a plan view illustrating a configuration of another coating material according to the embodiment of the present invention.

FIG. 2C is a plan view illustrating a configuration of another coating material according to the embodiment of the present invention.

FIG. 2D is a plan view illustrating a configuration of another coating material according to the embodiment of the present invention.

FIG. 3 is a plan view illustrating a configuration of a sample used in experiments.

### DETAILED DESCRIPTION OF ILLUSTRATIVE EMBODIMENTS

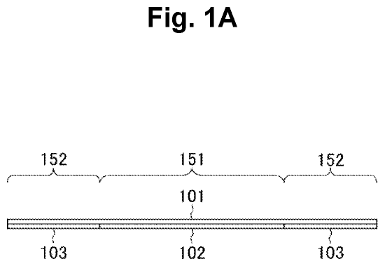

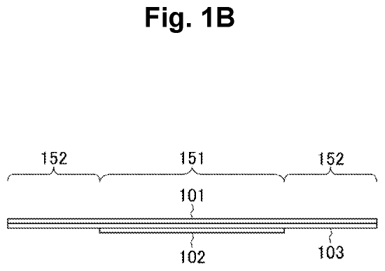

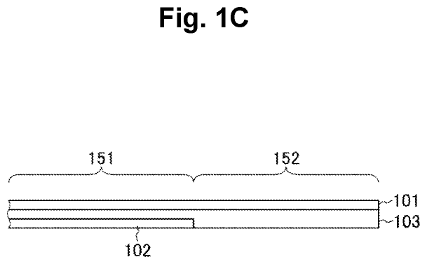

Hereinafter, a coating material according to an embodiment of the present invention will be described with reference to FIGS. 1A, 1B, and 1C. The coating material includes a base material 101 having a sheet-like or plate-like shape, and a non-adhesive layer 102 and an adhesive layer 103 formed on one surface of the base material 101.

The base material 101 is formed with a material that prevents intrusion of ultraviolet rays. In addition, it is important that the base material 101 is formed with a material having resistance in a test for evaluating deterioration of a polymer material mainly due to ultraviolet rays, for an accelerated light resistance test, an accelerated weather resistance test, an outdoor exposure test, and the like. The base material 101 can be formed with, for example, a polymer material containing an ultraviolet absorber, an antioxidant, a light stabilizer, carbon black, titanium dioxide, zinc oxide, cerium oxide, iron oxide, barium oxide, or mica. Furthermore, the base material 101 can be formed with metal.

The non-adhesive layer 102 is formed with a material that does not have adhesiveness to a polymer material, and is formed in a first region 151 of one surface of the base material 101. The non-adhesive layer 102 is formed with a polymer containing none of a hydroxyl group, an amino group, a carboxyl group, a carbonyl group, an ester bond, a urethane bond, a urea bond, an imide bond, an imino group, an aldehyde group, a vinyl group, a phenyl group, a nitro group, and a sulfonyl group.

The adhesive layer 103 is formed with a material having adhesiveness to a polymer material, and is formed in a second region 152 in which the first region 151 of one surface of the base material 101 is interposed. The adhesive layer 103 can be formed with the same material as the adhesive layer of a well-known masking tape.

Furthermore, in the coating material according to the embodiment, the surface of the non-adhesive layer 102 with the surface of the adhesive layer 103 can contact the surface of the material to be tested. For example, as illustrated in FIG. 1B, the adhesive layer 103 and the non-adhesive layer 102 may be laminated in this order on the base material 101. Furthermore, as illustrated in FIG. 1C, the surface of the non-adhesive layer 102 and the surface of the adhesive layer 103 may form the same plane. The surface height of the non-adhesive layer 102 as viewed from the base material 101 may be equal to or higher than the surface height of the adhesive layer 103, and the difference between the surface height of the non-adhesive layer 102 and the surface height of the adhesive layer 103 as viewed from the base material 101 may be 1.2 mm or less.

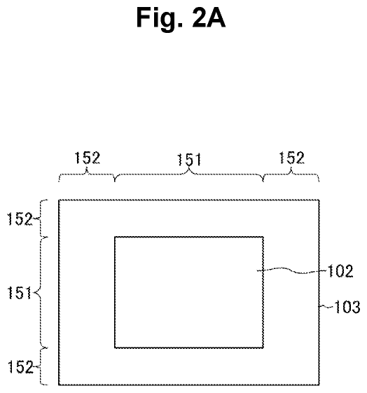

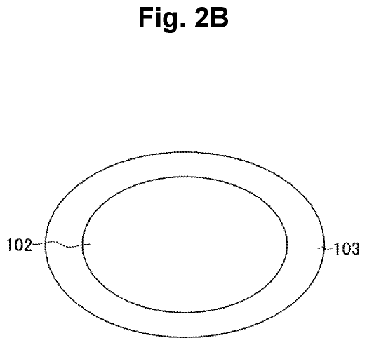

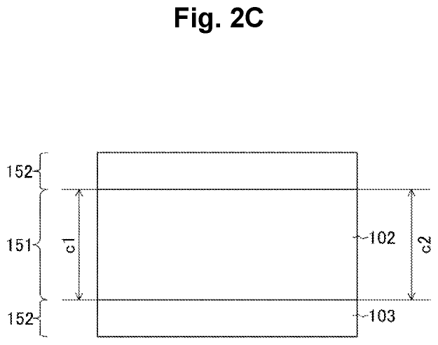

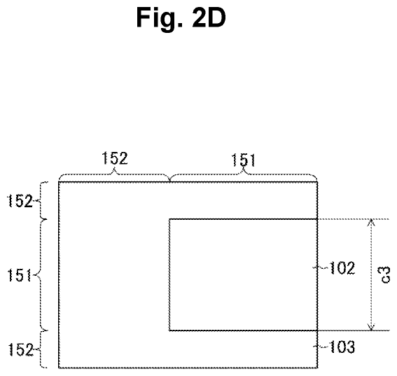

As illustrated in FIGS. 2A and 2B, the adhesive layer 103 can be formed in the second region 152 surrounding the first region 151 of one surface of the base material 101. The shape of the outer peripheries of the first region 151 and the second region 152 can be rectangular as illustrated in FIG. 2A. Furthermore, the shape of the outer peripheries of the first region 151 and the second region 152 can be elliptical (including a circle) as illustrated in FIG. 2B.

Furthermore, as illustrated in FIG. 2C, the non-adhesive layer 102 can be formed in the first region 151 that is in contact with a part of the side of the base material 101 in plan view. In this case, the total length (c1+c2) of the portion (circumscribed length) in contact with a part of the side of the base material 101 in plan view can be ½ or less of the outer peripheral length of the base material 101 in plan view.

Furthermore, as illustrated in FIG. 2D, the non-adhesive layer 102 can be formed in the first region 151 that is in contact with one portion of the side of the base material 101 in plan view. Also in this case, the length c3 of the portion in contact with a part of the side of the base material 101 (circumscribed length) in plan view can be ½ or less of the outer peripheral length of the base material 101 in plan view. Furthermore, in this case, the length c3 can be 4 cm or less.

Furthermore, the other surface of the base material 101 may have a color with lightness of 5 or more. With this configuration, in the test of irradiating ultraviolet rays, the temperature increase due to the irradiation of the ultraviolet rays can be suppressed, the expansion of the base material 101 can be prevented, and the deformation such as sagging can be suppressed.

In addition, a mark indicating a region in which the non-adhesive layer 102 is formed (first region 151) can be formed on the other surface of the base material 101. Since the coating material is used in a state where the non-adhesive layer 102 and the adhesive layer 103 are in contact with (abut) the surface of the material to be tested on one surface side of the base material 101, the non-adhesive layer 102 cannot be visually observed from the other surface of the base material 101. As a countermeasure, by providing the mark described above, the position of the non-adhesive layer 102 can be confirmed from the other surface of the base material 101. For example, in a case where both a deteriorated part and an undeteriorated part that is masked are formed in a test for deterioration evaluation by using a coating material, when the region in which the non-adhesive layer 102 is formed of the base material 101 is cut out and a surface of the undeteriorated part to be tested is exposed in a confirmation stage after the test, the region in which the non-adhesive layer 102 is formed can be reliably cut out.

Hereinafter, experimental results will be described.

### Experiment 1

First, Experiment 1 will be described. First, a test object piece was prepared by applying a resin paint with a thickness of 50 μm to an acrylic resin plate having a planar shape of a rectangle of 7 cm×15 cm. The applied paint is a urethane resin paint and an epoxy resin paint. The test object piece is a subject of a weather resistance test based on “JIS K 5600-7-7-A”. The weather resistance test based on “JIS K 5600-7-7-A” is a test in which “step A1: light irradiation intensity 60 W/m2 (wavelength 300 nm-400 nm), black panel temperature 63° C., in-tank temperature 38° C., in-tank humidity 50% RH, no water spray, treatment time T1=102 min” and “step B1: light irradiation intensity 60 W/m2 (wavelength 300 nm-400 nm), in-tank temperature 38° C., treatment time T2 using a spouting device=18 minutes” are repeated.

Next, a coating material was prepared. The base material 101 and the adhesive layer 103 of the prepared coating material were formed with an anti-grass sheet fixing tape No. 930 green (manufactured by Okamoto Industries, Inc.) and a sheet protection tape kst8020-wh (manufactured by Kikusui Tape Co., Ltd.). Since the other surface of the part of the base material 101 of the anti-grass sheet fixing tape No. 930 green is green, the sheet protection tape kst8020-wh was stuck in order to make the color of this surface higher in lightness. The sheet protection tape kst8020-wh has a color of about 9 in lightness.

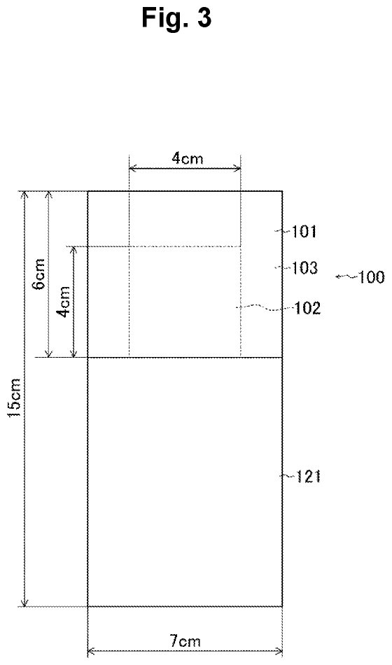

The non-adhesive layer 102 was formed (stuck) to a surface on which the adhesive layer 103 was formed of the anti-grass sheet fixing tape No. 930 green including the base material 101 and the adhesive layer 103 having the above-described configuration, to obtain a coating material. As illustrated in FIG. 3, a coating material 100 has a planar shape of a rectangle of 7 cm×6 cm. The non-adhesive layer 102 had a planar shape of a square of 4 cm×4 cm. In addition, the coating material 100 was stuck to a test object piece 121 in a state in which one long side of the coating material 100 overlapped one short side of the test object piece 121 to obtain a sample. In addition, the coating material 100 was disposed such that one side of the non-adhesive layer 102 overlapped the other short side of the coating material 100.

As described above, a sample in which the coating material 100 was stuck to the test object piece 121 as a mask was prepared, and the above-mentioned weather resistance test based on “JIS K 5600-7-7-A” was performed for 2000 hours. Thereafter, a cut was made in the portion of the coating material 100 in the portion of the non-adhesive layer 102 with a cutter to remove the coating material 100 and the base material 101 in this region, thereby exposing the surface of the test object piece 121 as an undeteriorated part. After the exposure, the attachment state of an adhesive substance or the like in the undeteriorated part of the test object piece 121 and the damage state of the coating film in the undeteriorated part were confirmed. The confirmation results are shown in Tables 1 and 2.

The item “non-adhesive layer” in Tables 1 and 2 indicates a material constituting the non-adhesive layer 102. In the sample No. 1 and the sample No. 9, the bluebossjan-60 (manufactured by KAMOI KAKOSHI Co., LTD.) for masking tape coating was used as a coating material, and a non-adhesive layer was not formed. The item “coating film” in Table 2 corresponding to “acrylic resin plate” is a sample obtained by performing a weather resistance test by sticking a coating material to a test object piece on which a coating film is not formed.

### [Table 1]

TABLE 1

| Sample | Coating | Non-adhesive | Undeteriorated part |
|---|---|---|---|
| No. | film | layer | surface state |
| 1 | Urethane resin | Commercially available | adhesive remained |
| | coating film | masking tape | |
| | | (adhesive surface) | |
| 2 | Urethane resin | Stainless steel | Sample damaged |
| | coating film | | |
| 3 | Urethane resin | Aluminum | Sample damaged |
| | coating film | | |
| 4 | Urethane resin | Zinc plating | Sample damaged |
| | coating film | | |
| 5 | Urethane resin | Glass | Sample damaged |
| | coating film | | |
| 6 | Urethane resin | Acrylic resin | Sample damaged |
| | coating film | | |
| 7 | Urethane resin | PET resin | Sample damaged |
| | coating film | | |
| 8 | Urethane resin | Cellulose | Sample damaged |
| | coating film | | |
| 9 | Epoxy resin | Commercially available | adhesive remained |
| | coating film | masking tape | |
| | | (adhesive surface) | |
| 10 | Epoxy resin | Stainless steel | Sample damaged |
| | coating film | | |
| 11 | Epoxy resin | Glass | Sample damaged |
| | coating film | | |
| 12 | Epoxy resin | Acrylic resin | Sample damaged |
| | coating film | | |
| 13 | Urethane resin | Polytetrafluoroethylene | No attached |
| | coating film | | substance and |
| | | | sample damage |
| 14 | Urethane resin | Tetrafluoroethylene- | No attached |
| | coating film | perfluoroalkyl vinyl | substance and |
| | | ether copolymer | sample damage |

### [Table 2]

TABLE 2

| Sample | Coating | Non-adhesive | Undeteriorated |
|---|---|---|---|
| No. | film | layer | part surface state |
| 15 | Urethane resin | Polyvinylidene | No attached |
| | coating film | fluoride | substance and |
| | | | sample damage |
| 16 | Urethane resin | Polyethylene | No attached |
| | coating film | | substance and |
| | | | sample damage |
| 17 | Urethane resin | Silicone resin | No attached |
| | coating film | | substance and |
| | | | sample damage |
| 18 | Epoxy resin | Polytetrafluoroethylene | No attached |
| | coating film | | substance and |
| | | | sample damage |
| 19 | Epoxy resin | Tetrafluoroethylene- | No attached |
| | coating film | perfluoroalkyl vinyl | substance and |
| | | ether copolymer | sample damage |
| 20 | Epoxy resin | Polyvinylidene | No attached |
| | coating film | fluoride | substance and |
| | | | sample damage |
| 21 | Epoxy resin | Polyethylene | No attached |
| | coating film | | substance and |
| | | | sample damage |
| 22 | Epoxy resin | Silicone resin | No attached |
| | coating film | | substance and |
| | | | sample damage |
| 23 | Acrylic | Polytetrafluoroethylene | No attached |
| | resin plate | | substance and |
| | | | sample damage |
| 24 | Acrylic | Tetrafluoroethylene- | No attached |
| | resin plate | perfluoroalkyl vinyl | substance and |
| | | ether copolymer | sample damage |
| 25 | Acrylic | Polyvinylidene fluoride | No attached |
| | resin plate | | substance and |
| | | | sample damage |
| 26 | Acrylic | Polyethylene | No attached |
| | resin plate | | substance and |
| | | | sample damage |
| 27 | Acrylic | Silicone resin | No attached |
| | resin plate | | substance and |
| | | | sample damage |

In sample No. 1 and sample No. 9 using the commercially available masking tape, the adhesive of the commercially available masking tape remained on the surface of the sample (undeteriorated part) was confirmed after removing the coating material.

The metal material, the inorganic material, and the plastic material are materials that do not have adhesiveness. The fact that a non-adhesive layer formed with any of these materials adheres to the coating film to damage the coating film cannot be easily inferred, but has been revealed for the first time by Experiment 1 that the inventors conducted.

Next, in sample Nos. 13 to 17 of the urethane resin coating film and sample Nos. 18 to 22 of the epoxy resin coating film, the non-adhesive layer formed with polytetrafluoroethylene, a tetrafluoroethylene-perfluoroalkyl vinyl ether copolymer, polyvinylidene fluoride, polyethylene, and a silicone resin. In these samples, no attached substance or damage was confirmed on the surface of the undeteriorated part after removing the coating material.

All of polytetrafluoroethylene, a tetrafluoroethylene-perfluoroalkyl vinyl ether copolymer, polyvinylidene fluoride, polyethylene, and a silicone resin are materials having a large contact angle when brought into contact with a liquid, and are materials having good detachability (Reference Literature).

Examples of the material having similar good detachability include a tetrafluoroethylene-hexafluoropropylene copolymer, a tetrafluoroethylene-ethylene copolymer, polychlorotrifluoroethylene, an ethylene chlorotrifluoroethylene copolymer, polyvinyl fluoride, polypropylene, and the like, and these polymer materials are considered to be suitable for use for the material of the non-adhesive layer 102. In addition, it is considered that a copolymer of a plurality of components and a mixture of a plurality of components among these are similarly suitable for use for the material of the non-adhesive layer 102. In the coating material according to the present invention, it cannot be easily inferred that it is important that the non-adhesive layer has detachability, and it can be said that the effectiveness has been confirmed for the first time by Experiment 1 that we conducted this time.

In addition, in sample Nos. 23 to 27 in which an acrylic resin plate on which no coating film was formed was used as a test object piece, when the non-adhesive layer includes polytetrafluoroethylene, a tetrafluoroethylene-perfluoroalkyl vinyl ether copolymer, polyvinylidene fluoride, polyethylene, or a silicone resin, there was no attached substance remained or a damage on the surface of the undeteriorated part. From these results, it has been confirmed that embodiments of the present invention are applicable even when the target of the test for deterioration evaluation is not a coating film but a resin plate.

Meanwhile, in Experiment 1, the commercially available anti-grass sheet fixing tape No. 930 green was used as the base material 101 and the adhesive layer 103. This is because when the base material 101 does not have light resistance or weather resistance, the base material 101 itself is deteriorated when an accelerated light resistance test, an accelerated weather resistance test, an outdoor exposure test, or the like is performed, and the coating function is not sufficiently exhibited. Therefore, as described above, like the commercially available adhesive tape or the like used in Experiment 1, it is important that the base material 101 includes a material having resistance in the test for deterioration evaluation for evaluating deterioration of a polymer material mainly due to ultraviolet rays, for an accelerated light resistance test, an accelerated weather resistance test, an outdoor exposure test, and the like. It has been confirmed by a separate analysis that the commercially available adhesive tape used in Experiment 1 contains an ultraviolet absorber.

For example, the base material 101 preferably includes a polymer material containing at least one of an ultraviolet absorber, an antioxidant, a light stabilizer, carbon black, titanium dioxide, zinc oxide, cerium oxide, iron oxide, barium oxide, and mica, or a material mainly including a metal material. In the material to be applied to the base material of the coating material according to embodiments of the present invention, when the ultraviolet transmittance is high, the ultraviolet deterioration also proceeds in a portion to be an undeteriorated part. Therefore, the base material desirably includes a material having a low ultraviolet transmittance within a possible range. Most preferably, the base material includes a material having an ultraviolet transmittance of 0.

### Experiment 2

Next, Experiment 2 will be described. First, a test object piece was prepared by applying a resin paint with a thickness of 50 μm to an acrylic resin plate having a planar shape of a rectangle of 7 cm×15 cm. The applied paint is a urethane resin paint and an epoxy resin paint. The test object piece is a subject of a weather resistance test based on “JIS K 5600-7-7-A”.

Next, a coating material was prepared. The prepared base material 101 of the coating material and the adhesive layer 103 were formed with the anti-grass sheet fixing tape No. 930 green and the sheet protection tape kst8020-wh. Since the other surface of the part of the base material 101 of the anti-grass sheet fixing tape No. 930 green is green, the sheet protection tape kst8020-wh was stuck in order to make the color of this surface higher in lightness.

The non-adhesive layer 102 was formed (stuck) to a surface on which the adhesive layer 103 was formed of the anti-grass sheet fixing tape No. 930 green including the base material 101 and the adhesive layer 103 having the above-described configuration, to obtain a coating material. The non-adhesive layer 102 was formed with polytetrafluoroethylene.

In addition, four kinds of coating materials were prepared in which the planar shapes of the base materials 101 were a shape 1 illustrated in FIG. 2A, a shape 2 illustrated in FIG. 2D, a shape 3 illustrated in FIG. 2C, and a shape 4 illustrated in FIG. 2B.

As described above, a sample in which the coating material 100 was stuck to the test object piece as a mask was prepared, and the above-mentioned weather resistance test based on “JIS K 5600-7-7-A” was performed for 2000 hours. Thereafter, a cut was made in the portion of the coating material 100 in the portion of the non-adhesive layer 102 with a cutter to remove the coating material 100 and the base material 101 in this region, thereby exposing the surface of the test object piece 121 as an undeteriorated part. After the exposure, the attachment state of an adhesive substance or the like in the undeteriorated part of the test object piece 121 and the damage state of the coating film in the undeteriorated part were confirmed. The confirmation results are shown in Table 3.

In Table 3, d is an outer peripheral length of the base material 101 in plan view. The item “proportion of non-adhesive layer on outer periphery” indicates the proportion of the circumscribed length of the non-adhesive layer 102 to the outer peripheral length of the base material 101. The item “non-adhesive layer thickness (mm)” in Table 3 is a difference between the surface height of the non-adhesive layer 102 and the surface height of the adhesive layer 103 as viewed from the base material 101.

### [Table 3]

TABLE 3

| | | Non- | | | |
|---|---|---|---|---|---|
| | | adhesive | Proportion of | | |
| | | layer | non-adhesive | Circumscribed | Undeteriorated |
| Sample | | thickness | layer on | length | part surface |
| No. | Shape | [mm] | outer periphery | [cm] | state |
| 28 | shape 1 | 2.0 | 0 | 0 | ∘ |
| 29 | shape 1 | 0.4 | 0 | 0 | ∘ |
| 30 | Shape 2 | 2.0 | 0 | 0 | ∘ |
| 31 | Shape 2 | 0.4 | 0 | 0 | ∘ |
| 32 | Shape 3 | 0.4 | c3 ÷ d = 0.2 | 2 | ∘ |
| 33 | Shape 3 | 0.4 | c3 ÷ d = 0.4 | 2 | ∘ |
| 34 | Shape 3 | 0.4 | c3 ÷ d = 0.5 | 2 | ∘ |
| 35 | Shape 3 | 0.4 | c3 ÷ d = 0.6 | 2 | x |
| 39 | Shape 4 | 0.4 | (c1 + c2) ÷ d = 0.2 | 2 | ∘ |
| 40 | Shape 4 | 0.4 | (c1 + c2) ÷ d = 0.4 | 2 | ∘ |
| 41 | Shape 4 | 0.4 | (c1 + c2) ÷ d = 0.5 | 2 | ∘ |
| 42 | Shape 4 | 0.4 | (c1 + c2) ÷ d = 0.6 | 2 | x |
| 43 | Shape 3 | 0.8 | c3 ÷ d = 0.2 | 2 | ∘ |
| 44 | Shape 3 | 1.2 | c3 ÷ d = 0.2 | 2 | ∘ |
| 45 | Shape 3 | 1.5 | c3 ÷ d = 0.2 | 2 | x |
| 46 | Shape 3 | 1.5 | c3 ÷ d = 0.2 | 2 | x |
| 47 | Shape 3 | 0.4 | c3 ÷ d = 0.2 | 4 | ∘ |
| 48 | Shape 3 | 0.4 | c3 ÷ d = 0.2 | 4.5 | x |

In sample Nos. 28 to 31, the properties of the surface of the undeteriorated part after removing the coating material were good. It was confirmed that the shape 1 and the shape 2 in which the periphery of the non-adhesive layer 102 was entirely the adhesive layer 103 were suitable for use regardless of the value of “non-adhesive layer thickness (mm)”. The planar shape of the base material 101 is exemplified as a quadrangle and an ellipse (circle), but may be any shape.

In sample Nos. 32 to 42, when c3÷d and (c1+c2)÷d were 0.5 or less, the properties of the surface of the undeteriorated part after removing the coating material were good. On the other hand, in sample Nos. 35 and 42 satisfying c3÷d=0.6 and (c1+c2)÷d=0.6, a sign of conceivable water infiltration into the part that had been in contact with the non-adhesive layer 102 was confirmed. From these results, it has been confirmed that c3÷d≤0.5 and (c1+c2)÷d≤0.5 are suitable.

In the evaluation of the wear amount of the coating film by the weather resistance test, the level difference between the undeteriorated part and the deteriorated part can be easily measured by continuously providing the undeteriorated part and the deteriorated part on the surface of the weather resistance test sample. Therefore, it is highly effective that shapes 3 and 4 are applicable. Here, the planar shapes of the base material 101 and the non-adhesive layer 102 are rectangular or elliptical, but the planar shapes of the base material 101 and the non-adhesive layer 102 may be any shapes.

Next, sample Nos. 43 to 45 will be described. In all of the sample Nos. 43 to 45, c3÷d=0.2 is satisfied, which is a condition eliminating problem such as water infiltration caused by the ratio of the circumscribed length of the non-adhesive layer 102 to the outer peripheral length of the base material 101. Under this condition, the circumscribed length c3 of the non-adhesive layer 102 is changed to 2 cm, 4 cm, and 4.5 cm with respect to the outer peripheral length of the base material 101 of 16 cm. In addition, the difference “non-adhesive layer thickness” between the surface height of the non-adhesive layer 102 and the surface height of the adhesive layer 103 as viewed from the base material 101 is changed.

As shown in the results of sample No. 43, sample No. 44, and sample No. 47, when the “non-adhesive layer thickness” was 1.2 mm or less, the properties of the surface of the undeteriorated part after removing the coating material were good. On the other hand, as shown in the results of sample No. 45 and sample No. 46, when ch=1.5 mm was satisfied, a sign of conceivable water infiltration into the part that had been in contact with the non-adhesive layer 102 was confirmed. From these results, it was found that making the difference between the surface height of the non-adhesive layer 102 and the surface height of the adhesive layer 103 as viewed from the base material 101 be 1.2 mm or less is suitable.

With respect to the circumscribed length of the non-adhesive layer 102, as shown in sample No. 48, when the length was set to 4.5 cm, a sign of conceivable water infiltration into the part that had been in contact with the non-adhesive layer 102 was confirmed, but when the length was 4 cm or less, the properties of the surface of the undeteriorated part were good. From these results, it was found that making the circumscribed length (total circumscribed length) of the non-adhesive layer 102 be 4 cm or less is suitable.

### Experiment 3

Next, Experiment 3 will be described. First, a test object piece was prepared by applying a resin paint with a thickness of 50 μm to an acrylic resin plate having a planar shape of a rectangle of 7 cm×15 cm. The applied paint is a urethane resin paint and an epoxy resin paint. The test object piece is a subject of a weather resistance test based on “JIS K 5600-7-7-A”.

Next, a coating material was prepared. The base material 101 of the prepared coating material and the adhesive layer 103 were formed with the anti-grass sheet fixing tape No. 930 green. In addition, the planar shape of the base material 101 was the shape illustrated in FIG. 2C.

The non-adhesive layer 102 was formed (stuck) to a surface on which the adhesive layer 103 was formed of the anti-grass sheet fixing tape No. 930 green including the base material 101 and the adhesive layer 103 having the above-described configuration, to obtain a coating material. The non-adhesive layer 102 was formed with polytetrafluoroethylene.

In addition, sample No. 49, sample No. 50, and sample No. 51 were prepared such that the surfaces of the base materials 101 including the anti-grass sheet fixing tape No. 930 green (the surface opposite to the surface to which the non-adhesive layer 102 was stuck) differed in the color (lightness) from each other.

As described above, samples (sample No. 49, sample No. 50, sample No. 51) in which the coating material 100 was stuck to the test piece as a mask was prepared, and the above-described weather resistance test based on “JIS K 5600-7-7-A” was performed for 2000 hours. Thereafter, a cut was made in the portion of the coating material 100 in the portion of the non-adhesive layer 102 with a cutter to remove the coating material 100 and the base material 101 in this region, thereby exposing the surface of the test object piece 121 as an undeteriorated part. After the exposure, the attachment state of an adhesive substance or the like in the undeteriorated part of the test object piece 121 and the damage state of the coating film in the undeteriorated part were confirmed. The confirmation results are shown in Table 4.

### [Table 4]

TABLE 4

| | | Undeteriorated part |
|---|---|---|
| Sample No. | Lightness | surface state |
| 49 | 8 | ∘ |
| 50 | 5 | ∘ |
| 51 | 4 | x |

In sample Nos. 49 and 50 in which the lightness of the base material 101 was 5 or more, the properties of the surface of the undeteriorated part after removing the coating material were good. On the other hand, in sample No. 51 in which the lightness of the base material 101 was 4, a sign of conceivable water infiltration into the part that had been in contact with the non-adhesive layer 102 was confirmed. From these results, it was found that making the lightness of the base material 101 be 5 or less is suitable. When the lightness of the base material 101 is low, the temperature of the base material 101 is increased by light irradiation, and a gap is likely to be generated between the non-adhesive layer 102 and the sample due to expansion of the base material 101.

As described above, according to embodiments of the present invention, since the non-adhesive layer and the adhesive layer are provided on one surface of the base material to form the coating material, it is possible to accurately perform a test for deterioration evaluation in which a deteriorated part and an undeteriorated part that is masked with the coating material are provided.

Note that the present invention is not limited to the embodiment described above, and it is obvious that many modifications and combinations can be made by those skilled in the art within the technical idea of the present invention.

### REFERENCE LITERATURE

Toshiyuki Ogawa, “Characteristics Properties of Polyfluoro Carbon Resins in Coatings”, Practical Surface Finishing, Vol. 28, No. 8, pp. 350-357,370 (1981).

### Reference Signs List

101 Base material
102 Non-adhesive layer
103 Adhesive layer
151 First region
152 Second region

1-8. (canceled)

9. A coating material comprising:
a base material having a sheet-like or plate-like shape made of a material that prevents intrusion of an ultraviolet ray;
a non-adhesive layer made of a material that does not have adhesiveness to a polymer material, the non-adhesive layer being disposed on a first region of a first surface of the base material; and
an adhesive layer made of a material that has adhesiveness to the polymer material, the adhesive layer being disposed on a second region and a third region of the first surface of the base material, and wherein the first region of the first surface of the base material is interposed between the second region and the third region of the first surface of the base material,
wherein the non-adhesive layer is formed with a polymer that does not contain any one of: a hydroxyl group, an amino group, a carboxyl group, a carbonyl group, an ester bond, a urethane bond, a urea bond, an imide bond, an imino group, an aldehyde group, a vinyl group, a phenyl group, a nitro group, or a sulfonyl group, and
wherein a surface of the non-adhesive layer and a surface of the adhesive layer are configured to contact a surface of a material to be tested.

10. The coating material according to claim 9, wherein the adhesive layer surrounds the first region of the first surface of the base material in a plan view.

11. The coating material according to claim 9, wherein one or more sides of the non-adhesive layer is coterminous with one or more sides of the base material in a plan view.

12. The coating material according to claim 11, wherein
a surface height of the non-adhesive layer is equal to or higher than a surface height of the adhesive layer, and
a difference between the surface height of the non-adhesive layer and the surface height of the adhesive layer is 1.2 mm or less.

13. The coating material according to claim 12, wherein a total length of the one or more sides of the non-adhesive layer coterminous with the one or more sides of the base material in the plan view is ½ or less of an outer peripheral length of the base material in the plan view.

14. The coating material according to claim 11, wherein a total length of the one or more sides of the non-adhesive layer coterminous with the one or more sides of the base material in the plan view is ½ or less of an outer peripheral length of the base material in the plan view.

15. The coating material according to claim 14, wherein:
one side of the non-adhesive layer is coterminous with one side of the base material in the plan view, and
a length of the one side of the non-adhesive layer that is coterminous with the one side of the base material in the plan view is 4 cm or less.

16. The coating material according to claim 9, wherein a second surface of the base material has a color with lightness of 5 or more.

17. The coating material according to claim 9, further comprising a mark that is disposed on a second surface of the base material and indicates the first region in which the non-adhesive layer is disposed.

18. A coating material comprising:
a base material that prevents intrusion of an ultraviolet ray;
a non-adhesive material that does not have adhesiveness to a polymer material, the non-adhesive material being disposed on a first surface of the base material; and
an adhesive material that has adhesiveness to the polymer material, the adhesive material being disposed on the first surface of the base material,
wherein the non-adhesive material is disposed between the adhesive material in a plan view,
wherein the non-adhesive material is a polymer that does not contain any one of: a hydroxyl group, an amino group, a carboxyl group, a carbonyl group, an ester bond, a urethane bond, a urea bond, an imide bond, an imino group, an aldehyde group, a vinyl group, a phenyl group, a nitro group, or a sulfonyl group, and
wherein a surface of the non-adhesive material and a surface of the adhesive material are configured to contact a surface of a material to be tested, the surface of the non-adhesive material and the surface of the adhesive material each being opposite to the base material.

19. The coating material according to claim 18, wherein the adhesive material surrounds the non-adhesive material in the plan view.

20. The coating material according to claim 18, wherein one or more sides of the non-adhesive material is coterminous with one or more sides of the base material in the plan view.

21. The coating material according to claim 20, wherein
a surface height of the non-adhesive material is equal to or higher than a surface height of the adhesive material, and
a difference between the surface height of the non-adhesive material and the surface height of the adhesive material is 1.2 mm or less.

22. The coating material according to claim 20, wherein a total length of the one or more sides of the non-adhesive material coterminous with the one or more sides of the base material in the plan view is ½ or less of an outer peripheral length of the base material in the plan view.

23. The coating material according to claim 20, wherein:
one side of the non-adhesive material is coterminous with one side of the base material in the plan view, and
a length of the one side of the non-adhesive material that is coterminous with the one side of the base material in the plan view is 4 cm or less.

24. The coating material according to claim 18, wherein a second surface of the base material has a color with lightness of 5 or more.

25. The coating material according to claim 15, further comprising a mark that is disposed on a second surface of the base material and indicates the first region in which the non-adhesive layer is disposed, the second surface of the base material being opposite the first surface of the base material.

26. The coating material according to claim 18, wherein the non-adhesive material and the adhesive material each contact the first surface of the base material.

27. The coating material according to claim 18, wherein the adhesive material is disposed between the first surface of the base material and the non-adhesive material.
